(19) United States
(12) Patent Application Publication
(10) Pub. No.: US 2014/0166545 A1
(43) Pub. Date: Jun. 19, 2014

(54) ASYMMETRIC MAGNETIC FIELD NANOSTRUCTURE SEPARATION METHOD, DEVICE AND SYSTEM

(71) Applicants: Joseph W. Lyding, Champaign, IL (US); Charishma Puliyanda Subbaiah, New York, NY (US); Joshua D. Wood, Reynolds, IL (US)

(72) Inventors: Joseph W. Lyding, Champaign, IL (US); Charishma Puliyanda Subbaiah, New York, NY (US); Joshua D. Wood, Reynolds, IL (US)

(21) Appl. No.: 14/004,364

(22) PCT Filed: Mar. 16, 2012
(86) PCT No.: PCT/US12/29458

§ 371 Date: Nov. 25, 2013

Related U.S. Application Data
(60) Provisional application No. 61/453,798, filed on Mar. 17, 2011.

(51) Int. Cl. B03C 1/023

(52) U.S. Cl. CPC B03C 1/023
USPC 209/212

(57) ABSTRACT

A preferred method of the invention separates metallic or charged nanostructures in solution. In preferred embodiments, metal and semiconducting nanostructures are separated in solution with use of a net Lorentz force applied to metallic or conductive nanostructures. In other embodiments, charged nanostructures are separated from other nanostructures in solution. The charge can be applied to semiconducting or insulating nanostructures of a predetermined size by application of appropriate radiation. The method is conducted on dispersed nanostructures suspended in solution in a vessel. The net Lorentz force to metallic, conductive or charged nanostructures within the solution moves the metallic, conductive or charged nanostructures toward a common volume in a portion of the vessel. Extraction of the common volume provides solution with a high ratio of the metallic, conductive or charged nanostructures. The solution left behind has a high ratio of semiconducting or insulating nanostructures. That solution can also be recovered.

### PRIORITY CLAIM AND REFERENCE TO RELATED APPLICATION

This application claims benefit under 35 U.S.C. §119 and all applicable statues and treaties from prior U.S. provisional application No. 61/453,798, which was filed on Mar. 17, 2011 and entitled Asymmetric Magnetic Field Nanostructure Separation Method, Device and System.

### STATEMENT OF GOVERNMENT INTEREST

This invention was made with government support under contract number N00014-06-10120 awarded by Office of Naval Research. The government has certain rights in the invention.

### FIELD

A field of the invention is nanostructure separation. A preferred application of the invention particularly concerns the separation of semiconducting carbon nanotubes and metallic carbon nanotubes. Other nanostructures that can be separated include, graphene nanoribbons, semiconducting nanowires, and semiconducting quantum dots.

### BACKGROUND

Carbon nanotubes (CNTs) are nanometer-sized cylinders of carbon atoms with differing electronic properties based on how one rolls the carbon atoms. These differing CNT electronic types are semiconducting and metallic, and by growing CNTs one typically gets a CNT electronic distribution of ⅔ semiconducting and ⅓ metallic CNTs.

Most CNT-related applications require electronic type control. For example, to use CNTs as an ideal transparent electrode for photovoltaics (see Green et al., “Colored semitransparent conductive coatings consisting of monodisperse metallic single-walled carbon nanotubes,” Nano Letters 8, 1417 (2008)), one must have only metallic CNTs. Conversely, employing CNTs in a transistor—such as a replacement for silicon-based CMOS—necessitates the use of semiconducting CNTs in the channel, for having metallic CNTs within the channel prevents one from turning off the switch (see Engel et al., “Thin Film Nanotube Transistors Based on Self-Assembled, Aligned, Semiconducting Carbon Nanotube Arrays,” ACS Nano 2, 2445 (2008)). Normal CNT growth processes give a random distribution of metallic and semiconducting CNTs, limiting the possible number of CNT applications. As yet there is no known process to synthesize chirally pure carbon nanotubes.

Prior techniques for CNT electronic separation include density gradient ultracentrifugation. See, e.g., Arnold et al., “Sorting carbon nanotubes by electronic structure using density differentiation,” Nature Nanotechnology 1, 60 (2006); dielectrophoresis, Krupke et al., “Separation of Metallic from Semiconducting Single-Walled Carbon Nanotubes,” Science 301, 344 (2003). The density gradient centrifugation process is commercially practiced, such as by NanoIntegris, and is scalable. However, density gradient separation tends to destroys longer CNTs in its processing. Additionally, iterations of the process are expensive. A single stage of the process requires an ultra-centrifuge. These machines have a typical cost of $250,000 each. Adding stages to gradually increase the purity of separated nanotubes adds significant costs.

Another technique, dielectrophoresis, requires pre-deposited metal electrodes on a surface for separation and its scalability is therefore difficult. This technique is complicated by sensitivity to the solution, contact metals, voltage waveform, contact separation, separation time, and surface employed, making consistent separation challenging. For scalability and purity of CNTs, the requirement to deposit on electrodes to achieve separation is a limiting factor.

DNA separation is another published technique. In this technique, certain sequences of DNA selectively attach to chiralities of CNTs in solution. This technique is highly selective, but is slow, expensive and not readily scaled.

Another issue with prior techniques such as density gradient ultrasonification is their inability to work without surfactants. Some end uses of CNTs would benefit from avoiding the use of surfactants during CNT separation. For example, in density gradient ultracentrifugation, co-loaded surfactants, like sodium dodecyl sulfate (SDS) and sodium cholate (SC), are necessary to separate, and these surfactants must be carefully loaded to separate metallic and semiconducting CNTs effectively.

### SUMMARY OF THE INVENTION

A preferred method of the invention separates metallic, conductive or charged nanostructures in solution. In preferred embodiments, metallic or conductive nanostructure are separated from semiconducting or insulating nanostructures in solution with use of a net Lorentz force applied to metallic or conductive nanostructures. In other embodiments, charged nanostructures are separated from other nanostructures in solution. The charge can be applied to semiconducting or insulating nanostructures of a predetermined size by application of appropriate radiation. The method is conducted on dispersed nanostructures suspended in solution in a vessel. The net Lorentz force to metallic, conductive or charged nanostructures within the solution to move the metallic, conductive or charged nanostructures toward a common volume in a portion of the vessel. Extraction of the common volume provides solution with a high ratio of the metallic, conductive or charged nanostructures. The solution left behind has a high ratio of semiconducting or insulating nanostructures. That solution can also be recovered.

### BRIEF DESCRIPTION OF THE DRAWINGS

FIG. 1A is a diagram of an experimental set-up and device used to demonstrate a method of the invention for separating metallic and semiconducting carbon nanotubes; and

FIG. 1B is a schematic diagram of a system for separating nanostructures;

FIG. 2 illustrates a sample asymmetric voltage waveform used in experiments demonstrating a method of the invention for separating metallic and semiconducting carbon nanotubes;

FIGS. 3A and 3B respectively show available states (density of states) for both a semiconducting CNT (FIG. 3A) and a metallic CNT (FIG. 3B) with respect to energy;

FIG. 4 shows optical absorbance measurement of CNTs in experiments using a method of the invention with absorbance measured in the ultraviolet, visible, and near infrared wavelength spectrum; and

FIG. 5 shows another set of optical absorbance measurements for CNTs with the same diameters and concentration as FIG. 4 before and after separation conducted in experiments of the invention.

### DETAILED DESCRIPTION OF THE PREFERRED EMBODIMENTS

The present inventors have recognized that it is better to maintain the nanostructures in solution during the process of separation and have provided a method for accomplishing the same that is efficient, scalable and inexpensive. Such solution based separation makes the processes of the invention simpler and amendable to many industrial processes. Process of the invention also work with or without surfactants. Methods of the invention are applicable to nanostructures that can be provided in solution and include a distribution of metallic, semiconducting and insulating nanostructures or a distribution of semiconductor nanostructures of different sizes. Example nanostructures that can be separated by the invention include CNTs, graphene nanoribbons, semiconducting nanowires, and semiconducting quantum dots. Previous CNT electronic separation techniques known to the inventors are limited in their throughput and ability to preserve CNT length. Methods, devices and systems of the invention address these concerns, allowing a large number of CNTs to be purified electronically at once and keeping longer CNTs intact. Embodiments of the invention are industry compatible, easily scalable, and are much less expensive than state of the art commercial techniques known to the inventors.

Embodiments of the invention can provide electronically pure metallic, conductive, semiconducting or insulating nanostructures for a variety of applications, including those listed above. Preferred embodiments provide electronically pure metallic or semiconducting CNTs. Embodiments of the invention can also separate other nanostructures, such as graphene nanoribbons, semiconducting nanowires, and semiconducting quantum dots.

In a preferred method of the invention, CNTs suspended in solution are contained in a vessel. A net Lorentz force is applied to metallic carbon nanotubes in one direction. The net Lorentz force moves the metallic carbon nanotubes in the direction of the force, e.g., toward a common volume that is a portion of the vessel, e.g., at the top of the vessel. Preferably, the nanotubes are dispersed prior to separation for the purpose of separating carbon nanotubes that bundle due to van der Waal's forces. Agitation can be used to accomplish the dispersing. Collecting solution from common volume, e.g., the top of the vessel, yields a solution with a high ratio of metal to semiconducting carbon nanotubes. The solution remaining in the vessel yields a solution with a high ratio of semiconducting to metallic carbon nanotubes. The process can be iterated inexpensively to gradually increase the ratios, achieving very pure solutions of either metal or semiconducting carbon nanotubes.

No surfactant is necessary during separation, which is beneficial for maintaining purity of carbon nanotubes for certain end-uses. However, surfactant can also be used to improve the efficiency of separation. If used, surfactant is preferably added during agitation of the nanotubes, but can also be applied shortly after agitation prior to significant re-bundling of carbon nanotubes. The separation by application of Lorentz forces to metallic nanotubes or other nanostructures is preferably conducted in the dark, which increases efficiency by avoiding the build up of charge on semiconducting carbon nanotubes due to interaction with light.

In a preferred embodiment, the vessel includes a layer of clean solution on top of the solution of nanotubes that will be separated. The Lorentz forces move the metallic nanotubes into the clean solution, which further enhances the separation because the clean solution layer lacked semiconducting nanotubes prior to the separation step.

In preferred embodiments, an asymmetric magnetic field produces the Lorentz forces on metallic carbon nanotubes to move them during separation. The asymmetric magnetic field can be generated with an electromagnet, such as a coil that is disposed inside the solution or around the vessel that contains the solution. Multiple coils in parallel in the solution, or stacked vertically in the solution or around the vessel can also be used. The magnetic field can be made to have a net force in one direction while maintaining an alternating waveform within reasonable voltage boundaries by making the waveform be rapid in its rise and gradual in its fall, for example. Advantageously, no moving parts are required with the electromagnet. Less preferred are mechanical arrangements that move permanent magnets to generate the net force in one direction, but such a technique can carry out a method of the invention.

In another preferred embodiment, semiconducting nanostructures, e.g. carbon nanotubes of specific diameter, are moved and separated by Lorentz force. The semiconducting nanotubes to be moved are first excited by application of a specific wavelength of radiation that is related to the specific diameter. A formula relating excitation wavelength to nanotube diameter is: S₁₁(nm)=1719.6×diameter (nm). Thus, with a solution containing a mix of semiconducting nanotubes in a vessel (such as after separation of metallic carbon nanotubes as discussed above), illumination ˜1720 nm wavelength radiation, semiconducting carbon nanotubes with diameters of 1 nm and larger are excited into a conductive state and can be moved by Lorentz forces in accordance of the invention. Chiral purity can be achieved through a successive process in which the excitation wavelength is shortened to select and separate the next smallest diameter.

The methods described with respect to carbon nanotubes can also be used with other metallic and semiconducting nanostructures that can be dispersed in solution. Graphene nanoribbons (GNRs) are one such nanostructure made up of one to several atomic layers of hexagonally arrayed carbon atoms. GNRs have either semiconducting or metallic behavior depending on their size and edge atomic structure, and for semiconducting GNRs the energy bandgap varies inversely with ribbon width. Consequently, metallic GNRs could be separated from semiconducting GNRs and then the semiconducting GNRs could be separated using the same optical excitation method described for CNTs.

Semiconducting nanowires (NWs) and semiconducting quantum dots (QDs), typically composed of column IV elements like Si or Ge, column III and column V elements like GaAs, InAs, GaN, etc., and column II and column VI elements like CdS and CdSe, exhibit size-dependent bandgap properties. Consequently, they could be separated by electronic character using the optical excitation/Lorentz force version described above for CNTs and GNRs.

A preferred device of the invention is vessel with one or more coil electromagnets around or in it, an alternating voltage source for applying power to the electromagnet(s), and a controller that controls the voltage source to apply an asymmetric varying waveform having a rapid or gradual rise, and the opposite fall, to generate an asymmetric magnetic field. Preferably a system includes a plurality of vessels in sequence, and a robotic fluid transfer device to sequential move increasingly purified solutions of carbon nanotubes to subsequent vessels while beginning a new cycle in an initial vessel. Preferred embodiment methods, devices and systems of the invention are simple and inexpensive and preserve CNT structure.

Embodiments of the invention purify carbon nanotubes by their electronic type in solution. In experiments conducted in accordance with the invention, carbon nanotubes were grown and placed in a solvent. The solvent is filled into a test tube that serves as the vessel, and the carbon nanotubes are dispersed into solution by ultrasonic agitation. The test tube is wrapped with copper windings and capped with a stopper. A voltage waveform is applied to the copper windings; the waveform is a pulsed, ramped wave with an asymmetric rise and fall time. This asymmetry generates a net magnetic force, which couples more strongly with the metallic carbon nanotubes than with the semiconducting carbon nanotubes. By Lorentz force, this stronger coupling separates the metallic carbon nanotubes from the semiconducting ones over a reasonable time period (˜10-24 hours), enriching the electronic distribution with metallic carbon nanotubes. These metallic carbon nanotubes are removed carefully from the solution for further analysis and application. Moreover, the remaining solution is enhanced with semiconducting carbon nanotubes, and this process can then also be repeated on the separated fractions to achieve further purity as needed.

The invention does not require expensive centrifugation, and surfactants can be avoided if desired. Methods of the invention are substantially simpler than popular commercial techniques, are inexpensive—and do not significantly affect carbon nanotube structure. In industrial applications, carbon nanotubes typically will be dispersed into a solution and deposited onto the surface(s) of choice. The separation provided by the invention occurs entirely within solution, making integration in a standard industrial process straightforward. The test tube used for separation can be replaced by an array of test tubes or with one larger separatory column.

Preferred embodiments of the invention will now be discussed with respect to the drawings and experiments that were conducted to demonstrate the invention. The drawings may include schematic representations, which will be understood by artisans in view of the general knowledge in the art and the description that follows. Features may be exaggerated in the drawings for emphasis, and features may not be to scale. Artisans will recognize broader aspects of the invention from the above description read with the following information about the specific experiments.

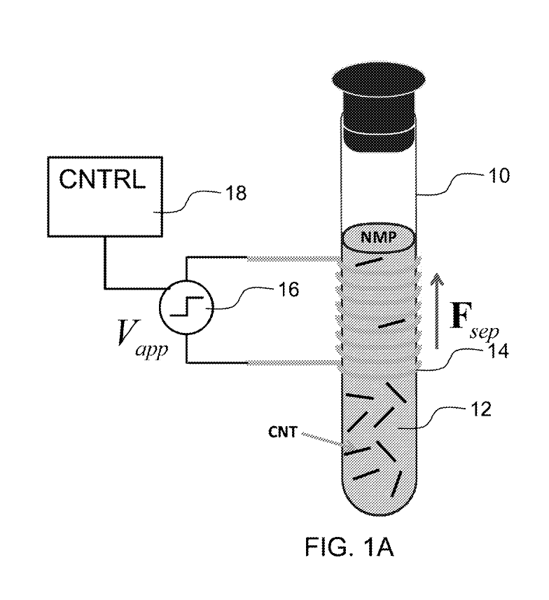

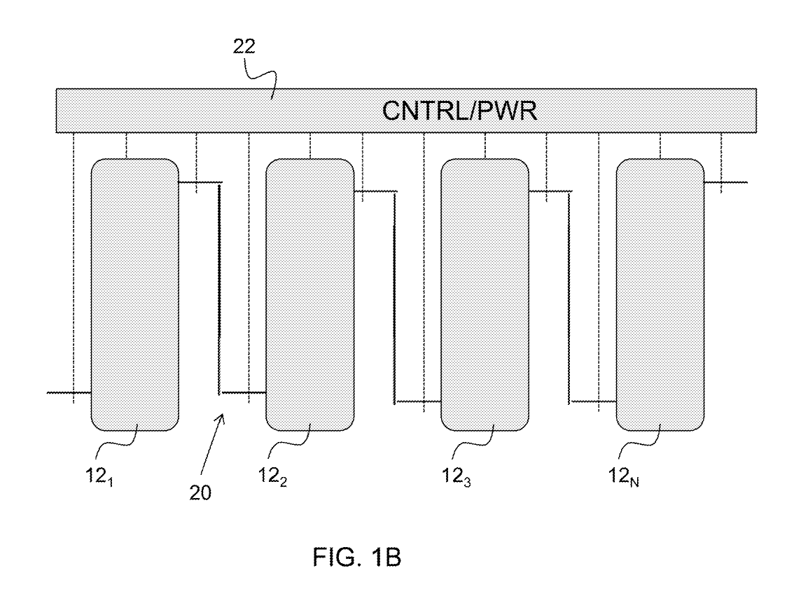

FIG. 1A illustrates a device used in experiments of the invention to conduct separation of metallic and semiconducting carbon nanotubes. In the FIG. 1 device, a vessel 10 held a solution 12 including a dispersion of carbon nanotubes (CNT). A coil 14 wrapped around the outside of the tube and was driven by a voltage source 16 that was controlled by a controller 18. The coil was excited by a waveform that produced a net magnetic separation force Fₛₑₚ. This separation force Fₛₑₚ was demonstrated to successful separate metallic or charged carbon nanotubes into a portion of the solution volume toward the top of the vessel. Of course, the force can be a net force in the opposite direction as well. The portion of the solution 12 near the top can be removed, such as by siphoning in the experiments and will have a high concentration of the metallic or charged nanostructures. The process can be iterated in one or multiple vessels to produce successively higher concentrations.

FIG. 1B illustrates an example system for conducting methods of the invention. The system includes multiple vessels 12₁-12_{N}. Flow between vessels is via a valved fluid network 20. A controller and power source 22 (or network of individual controllers/sources) controls the cycle of fluid flow and separation. In the embodiment shown in FIG. 1B, coils 14 are disposed in the vessels 12 and are not shown. The process can be automated and iterative, and is scalable for commercial use. The system in FIG. 1B can be part of a larger manufacturing system that makes use of separated nanostructures of desired nature (semiconducting, metallic, conductive, insulating or a particular size).

In the experiments conducted with the FIG. 1A set up, single wall carbon nanotubes (SWNTs) were separated, increasing the relative distribution of metallic SWNTs in solution by a magnetically induced Lorentz force. Solutions of SWNTs in n-methylpyrrolidone were sonicated, making a disperse solution. A non-uniform voltage waveform is then applied to the coils. This waveform generates a magnetic field that couples more strongly with metallic SWNTs than semiconducting SWNTs, due to a higher metallic SWNT magnetic moment, separating the tubes by Lorentz force. By conducting SWNT spectrophotometric measurements in the UV-vis-IR region, we assess the separation effectiveness. From the extracted supernatant solution, we observed multi-fold absorbance enhancement in the metallic SWNT transition regions. Additionally, the small full-width at half maximum in the absorbance peaks suggests that we are selecting a small number of metallic chiralities in our separation.

In the experimental setup, a test tube contained the solution with dispersed carbon nanotubes. The solution can be changed depending on the level of dispersibility desired. The initial experiments were conducted using the solvent n-methylpyrrolidone (NMP), a non-polar, amide solvent that disperses single carbon nanotubes well.

Additionally, NMP's high dispersibility level obviates the need for carbon nanotubes to be coated with surfactant, as is the case with hydrophilic media like water. Not using surfactants can improve overall carbon nanotube application performance.

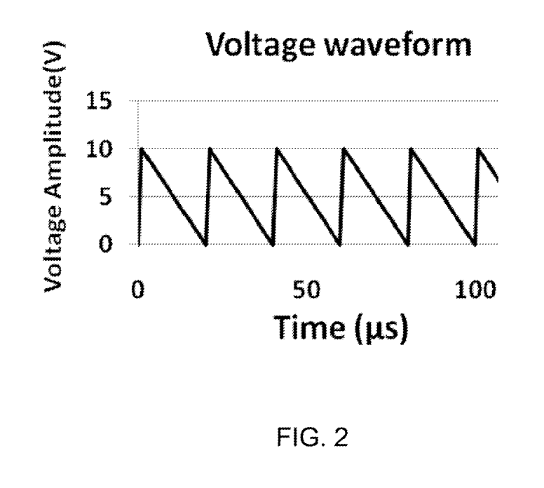

An asymmetric waveform Vₐₚₚ—such as the example in FIG. 2 having a rapid rise and gradual fall—is applied to the coil around the test tube, providing a carbon nanotube separatory force Fₛₑₚ. The experiment is run for ˜10-24 hours, with separated metallic carbon nanotubes rising to the top by the separatory force. Separated carbon nanotubes are extracted by micropipetting, with the top ˜1 mL being extracted. The FIG. 2 sample asymmetric voltage waveform used in experiments has a period of 21 μs, a voltage peak-to-peak of 10 V, and 5% symmetry, with a very steep rise compared to gradual fall

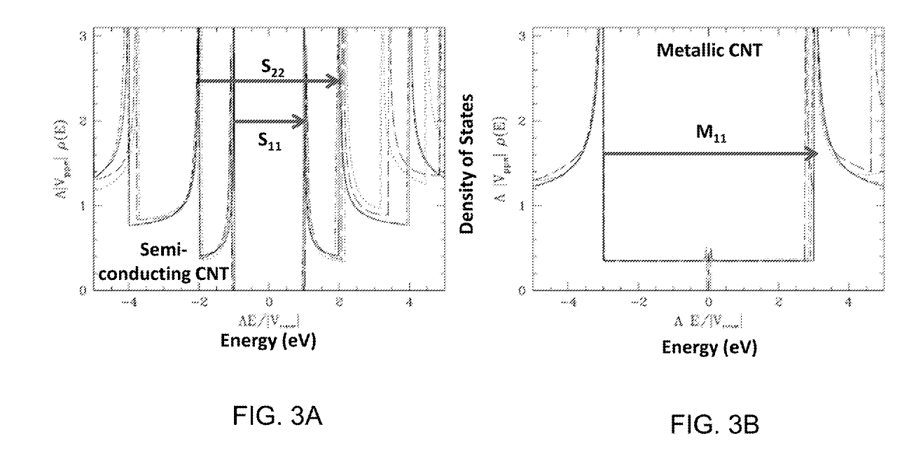

To assess the effectiveness of separation realized in the experiments, optical absorbance measurements were performed on the solution before the voltage waveform was applied and after it was applied. On the solution after field application, both the top extracted solution and the remaining solution were measured with optical absorbance techniques. The optical absorbance measurements were performed using a Cary 5G spectrophotometer housed at the Materials Research Laboratory, Laser. Spectroscopy Facility, Urbana, Ill. Semiconducting and metallic CNTs have different energy transitions based on their diameters. These energy transitions can be identified using optical absorbance methods, and example transitions are shown in FIGS. 3A and 3B. While additional energy transitions exist, the measurements focus on the lowest three transitions, namely, the S₁₁, S₂₂, and the M₁₁ transitions. S delimits a semiconducting CNT, and M here delimits a metallic CNT. FIGS. 3A and 3B respectively show available states (density of states) for both a semiconducting CNT (FIG. 3A) and a metallic CNT (FIG. 3B) with respect to energy. The different energy transitions for the semiconducting and metallic CNTs are indicated in the diagram, specifically, S₁₁, S₂₂, and M₁₁, respectively. These energy transitions can be probed by optical absorbance techniques.

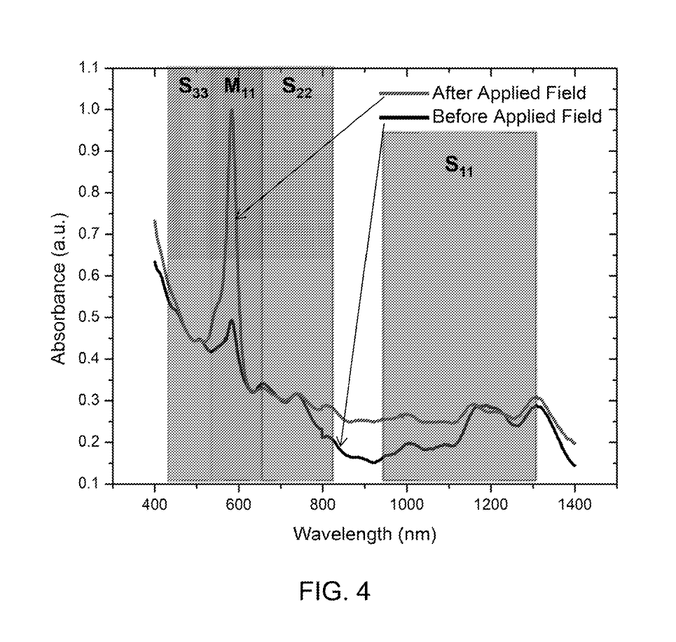

FIG. 4 shows optical absorbance measurement of separated CNTs in the ultraviolet, visible, and near infrared wavelength spectrum. CNTs with diameters from 0.8 to 1.2 nm were separated, giving the electronic transitions indicated in the red and blue regions, respectively (S₁₁, S₂₂, and so forth). Post separation, the measurement shows a three-fold enhancement in the M₁₁ electronic transition region, corresponding to metallic CNTs.

For the FIG. 4 measurements, 3 mg of high pressure carbon monoxide (HiPco) CNTs were dispersed into 15 mL of NMP solution by 20 min of ultrasonic agitation. After 24 hours of separation using the waveform in FIG. 2 (continuous pulsing), one notes the strong enhancement of a CNT metallic transition peak in the M₁₁ range. It is approximately three-fold higher than the peak in before field solution. Prior work by Green et al. used a density gradient separation method with an ultracentrifuge. Prior work by Itkis et al. describes the optical absorbance characterization process. These papers provide background to validate the characterization methodology used to verify our experimental results. Following the distribution extraction technique described Green et al., “Colored semitransparent conductive coatings consisting of monodisperse metallic single-walled carbon nanotubes,” Nano Letters 8, 1417 (2008) and Itkis et al., “Purity Evaluation of As-Prepared Single-Walled Carbon Nanotube Soot by Use of Solution-Phase Near-IR Spectroscopy,” Nano Letters, 2003, 3 (3), pp 309-314, solution after separation has 84.9% metallic CNTs and 15.1% semiconducting CNTs. This is in marked contrast to the randomly distributed CNT solution before the applied field, which had 33% metallic and 67% semiconducting CNTs, giving an enhancement factor of 257% in just a single stage of separation

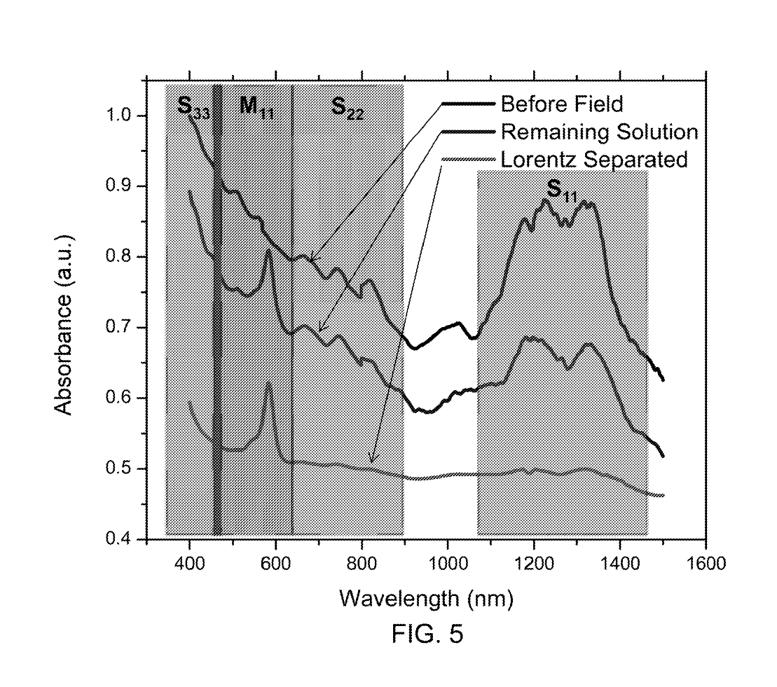

FIG. 5 shows another set of optical absorbance measurements for CNTs with the same diameters and concentration as FIG. 4. After 24 hours of separation using the waveform in FIG. 2 (continuous pulsing), there is once again a strong CNT metallic transition peak in the M₁₁ range. This solution after separation has 91.3% metallic CNTs and 8.7% semiconducting CNTs. Compared to the randomly distributed CNT solution before the applied field, this solution has an enhancement factor of 276% in just a single stage of separation.

The remaining solution has a much stronger metallic peak than the starting solution. This is due to the low concentration of CNTs extracted from the top profile (the “Lorentz separated” curve) and due to buoyant metallic CNTs in spatially distributed through the solution. Since a small amount of CNTs were extracted, it possible that many metallic CNTs are still within the remaining solution that need to be extracted. It is also possible that the starting solution was not fully dispersed, suggesting that a longer sonication time—greater than 20 minutes—is necessary to get a monodisperse CNTs solution. Additional runs on this sample continually remove metallic CNTs, eventually leaving a solution with is enriched in semiconducting CNTs.

While specific embodiments of the present invention have been shown and described, it should be understood that other modifications, substitutions and alternatives are apparent to one of ordinary skill in the art. Such modifications, substitutions and alternatives can be made without departing from the spirit and scope of the invention

Various features of the invention are set forth in the appended example claims.

1. A method for separating nanostructures in solution comprising:
providing dispersed nanostructures suspended in solution in a vessel;
applying a net Lorentz force to metallic, conductive or charged nanostructures within the solution to move the metallic, conductive or charged nanostructures toward a common volume in a portion of the vessel; and
extracting solution from the common volume.

2. The method of claim 1, wherein the metallic, conductive or charged nanostructures comprise metallic nanostructures and the solution extracted by said extracting has a high ratio of metallic, conductive or charged nanostructures to semiconducting or insulating nanostructures.

3. The method of claim 1, wherein the nanostructures comprise graphene nanoribbons.

4. The method of claim 1, wherein the nanostructures comprise carbon nanotubes.

5. The method of claim 1, wherein said providing comprises agitating the solution to disperse nanostructures.

6. The method of claim 1, conducted without surfactants in the solution.

7. The method of claim 1, conducted with surfactants in the solution.

8. The method of claim 1, conducted in the dark.

9. The method of claim 1, wherein said applying comprises generating an asymmetric magnetic field with an electromagnet driven by an alternating waveform having one of a rapid rise and gradual fall or a gradual rise and rapid fall.

10. The method of claim 1, further comprising transferring the extracted solution to another vessel and repeating said applying and extracting.

11. The method according to claim 1, wherein the metallic, conductive or charged nanostructures comprise metallic nanostructures and further comprising a step of exciting semiconducting or insulating nanostructures in said solution with radiation to produce the conductive or charged nanostructures.

12. The method of claim 11, wherein the semiconducting or insulating nanostructures comprise semiconducting carbon nanotubes having diameter dependent bandgap properties.

13. The method of claim 11, wherein the semiconducting or insulating nanostructures comprise nanowires having size dependent bandgap properties.

14. The method of claim 11, wherein the semiconducting or insulating nanostructures comprise quantum dots having size dependent bandgap properties.

15. A method for separating nanostructures in solution comprising:
providing dispersed nanostructures suspended in solution in a vessel;
exciting semiconducting nanostructures having sizes exceeding a predetermined size with radiation of a specific wavelength selected according to the predetermined size;
applying a net Lorentz force to move excited semiconducting or insulating nanostructures within the solution to move the excited semiconducting or insulating nanostructures toward a common volume in portion of the vessel; and
extracting solution from the common volume.

16. The method of claim 15, conducted on a solution that is first processed to remove metallic or conductive nanostructures from the solution.

17. The method of claim 15, conducted successively to obtain chiral purity through a successive process in which the excitation wavelength is shortened to select and separate successively smaller sizes of excited semiconducting or insulating nanostructures.

18. The method of claim 15, wherein the semiconducting nanostructures comprise carbon nanotubes having diameter dependent bandgap properties.

19. The method of claim 15, wherein the semiconducting or insulating nanostructures comprise nanowires having size dependent bandgap properties.

20. The method of claim 15, wherein the semiconducting or insulating nanostructures comprise quantum dots having size dependent bandgap properties.

21. A device for separating nanostructures in solution, the device comprising:
a vessel for containing solution including a dispersion of nanostructures;
an electromagnet disposed in or around said vessel; and
a signal generator for exciting the electromagnetic including programmed code for generating an asymmetric magnetic field in solution in said vessel to generate a net Lorentz force in said solution and vessel.
